(19) United States
(12) Patent Application Publication
(10) Pub. No.: US 2012/0062204 A1
(43) Pub. Date: Mar. 15, 2012

(54) Digital Voltage Converter Using A Tracking ADC

(75) Inventor: Dieter Draxelmayr, Villach (AT)

(73) Assignee: Infineon Technologies AG, Neubiberg (DE)

(21) Appl. No.: 12/882,483

(22) Filed: Sep. 15, 2010

(51) Int. Cl. G05B 24/02

(52) U.S. Cl. 323/318

(57) ABSTRACT

The disclosed DC-to-DC converter circuit comprises a tracking ADC configured to drive a DC-to-DC converter. In particular, the tracking ADC is configured to receive an analog feedback voltage from the output of the DC-to-DC converter. The analog feedback voltage is compared to an analog reference voltage and based upon the comparison a digital ADC output signal, comprising a digital code, is generated to drive the DC-to-DC converter. The digital ADC output signal is received by the DC-to-DC converter, which is configured to compare the digital code to a target code value. Based upon this comparison, the digital signal drives operation of the DC-to-DC converter by indicating whether the output of the DC-to-DC converter will be adjusted (e.g., by telling the DC-to-DC converter to increase its output voltage, to decrease its output voltage, or to keep its output voltage the same). Other systems and methods are also disclosed.

### FIELD OF INVENTION

The present invention relates generally to voltage converters and in particular to a digital voltage converter driven by a tracking analog-to-digital converter.

### BACKGROUND

Voltage converters are electrical circuits that are configured to receive an input voltage and based thereupon to provide an output voltage different than the input voltage. Voltage converters may comprise DC-to-DC converters, AC-to-DC converters, etc., for example.

DC-to-DC converters typically convert power from one DC voltage to another DC voltage (e.g., from 3V to 5V or from 5V to 3V). DC-to-DC converters are usually regulated devices, taking a possibly varying input voltage, and providing a stable, regulated output voltage, often up to some current (amperage) limit. In this way, DC-to-DC converters can in some instances be thought of as a “black box” that receives one voltage from a battery, for example, and converts it to another voltage that is used to power an integrated circuit.

This basic DC-to-DC conversion functionality makes DC-to-DC converters widely used for power conversion in many electronic systems, such as communications devices, among others.

### BRIEF DESCRIPTION OF THE DRAWINGS

FIG. 1 is a block diagram illustrating a DC-to-DC converter circuit having an analog-to-digital converter (ADC) that may be used to drive a DC-to-DC converter in accordance with some embodiments.

FIGS. 2A-2B are block diagrams illustrating more detailed embodiments of DC-to-DC converter circuits having an analog-to-digital converter (ADC) that may be used to drive a DC-to-DC converter in accordance with some embodiments.

FIG. 3 is a signal diagram illustrating various exemplary signals within the DC-to-DC converter circuit of FIG. 2A.

FIG. 4 is a block diagram illustrating an exemplary embodiment of a DC-to-DC converter circuit having a digital-to-analog converter shared between the DC-to-DC converter circuit and a voltage scaling circuit.

FIGS. 5A and 5B are block diagrams illustrating an exemplary embodiment of a DC-to-DC converter circuit of FIG. 2B in an equilibrium mode of operation.

FIG. 6 is a block diagram illustrating an additional embodiment of a DC-to-DC converter circuit in accordance with some embodiments.

FIG. 7 is a block diagram illustrating an additional embodiment of a DC-to-DC converter circuit comprising a post processing block.

FIG. 8 is a flowchart diagram illustrating a method for DC voltage conversion in accordance with some embodiments.

### DETAILED DESCRIPTION

One or more implementations of the present disclosure will now be described with reference to the attached drawings, where like reference numerals are used to refer to like elements throughout. Nothing in this detailed description is admitted as prior art.

It will be appreciated that although the following detailed description often describes a disclosed voltage converter in terms of a DC-to-DC converter circuit, that the disclosed invention is not limited to DC-to-DC converters/converter circuits. Rather, the disclosed use of a tracking ADC in a voltage converter circuit may broadly apply to voltage converter circuits having DC-to-DC converters or AC-to-DC converters, for example.

DC-to-DC converters are important components in many modern portable electronic devices that rely upon battery based power sources, such as cellular phones and laptop computers. In modern technology there is a trend to use digital DC-to-DC converters, which operate in the digital domain. Digital DC-to-DC converters offer many advantages over analog DC-to-DC converters such as consuming less silicon area, being more testable, more repeatable, more programmable, etc.

Digital DC-to-DC converter circuits may use an analog-to-digital converter (ADC) to drive the voltage output of a DC-to-DC converter. ADCs comprising flash converters, window flash converters, or sigma delta converters may generate a signal that drives digital DC-to-DC converters. However, these digital ADC options contain undesirable attributes. For example, a flash converter is fast, but contains hardware that utilizes large chip area and power. Accordingly, a digital voltage converter circuit configured to provide a digitized output with minimum hardware and power consumption is disclosed herein.

As provided herein, the disclosed voltage converter circuit (e.g., DC-to-DC converter circuit, AC-to-DC converter circuit) comprises a tracking ADC configured to drive a voltage converter. The tracking ADC is configured to receive an analog feedback voltage, from the output of the voltage converter, and to compare it to an analog reference voltage. The results of the comparison are used to generate a digital ADC output signal, comprising a digital code, that drives (e.g., adjusts) the output voltage of the voltage converter. In particular, the digital ADC output signal drives operation of the voltage converter by indicating whether the output of the voltage converter will be adjusted (e.g., by telling the voltage converter to increase its output voltage or to decrease its output voltage). Although a tracking ADC has a slow response time and is typically not a pre-designed hardware circuit block of general use it may be implemented into a voltage converter to provide an ADC that has low power consumption and chip area.

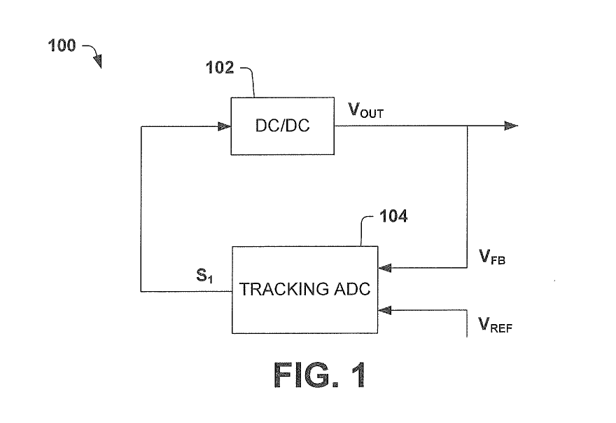

FIG. 1 illustrates a first embodiment of a DC-to-DC converter circuit 100 provided herein. As illustrated in FIG. 1, the DC-to-DC converter circuit 100 comprises a DC-to-DC converter 102 configured within a feedback loop comprising a tracking analog-to-digital converter (ADC) 104. The tracking ADC 104 is configured to receive an analog feedback voltage V_{FB} from the DC-to-DC converter 102. In various embodiments, the feedback voltage V_{FB} may comprise the output voltage V_{OUT} of the DC-to-DC converter 102 or some part of the output voltage V_{OUT}. Based upon a reference voltage V_{REF} and the received analog feedback voltage V_{FB}, the tracking ADC 104 is configured to generate a digital ADC output signal S₁ and to provide the digital ADC output signal S₁ to the digital DC-to-DC converter 102. The digital ADC output signal S₁ indicates how the output voltage of the DC-to-DC converter 102 should be adjusted (e.g., increased or decreased). In one embodiment, the digital ADC output signal S₁ may comprise a digital code (e.g., “100”).

The digital DC-to-DC converter 102 is configured to receive the digital ADC output signal S₁ and is driven by the digital ADC output signal S₁ to adjustably generate a stepped-up “boost” output voltage or a stepped down “buck” output voltage V_{OUT}, therefrom. In particular, the digital DC-to-DC converter 102 checks if the digital code of the received digital ADC output signal S₁ indicates whether the output voltage of the DC-to-DC converter should be increased or decreased to achieve a desired output voltage V_{OUT}.

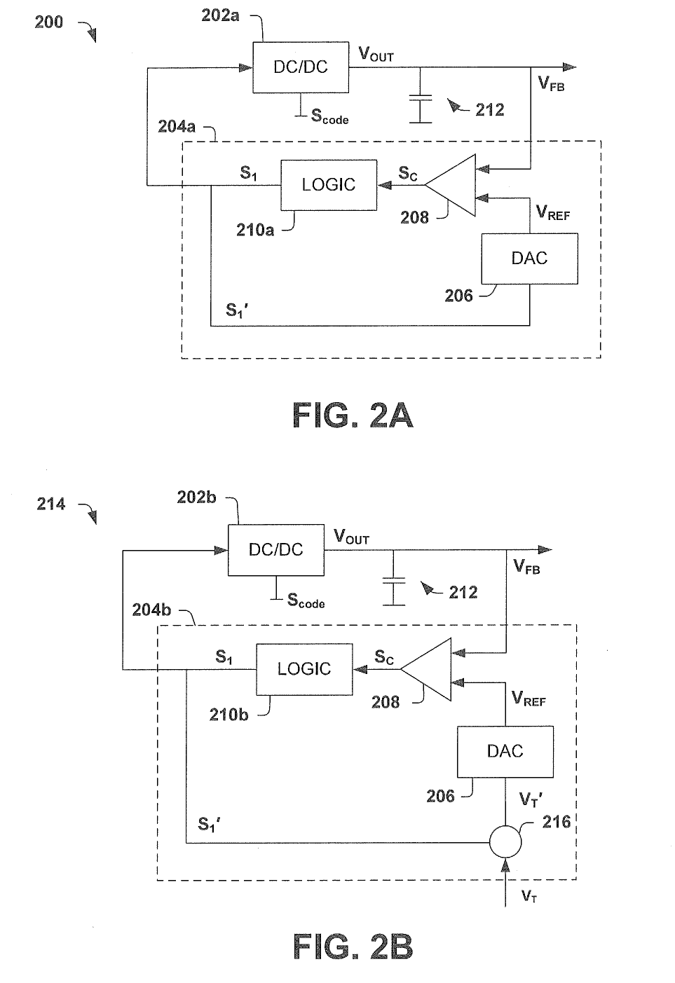

FIGS. 2A and 2B illustrate two exemplary embodiments of DC-to-DC converter circuits, 200 and 214, driven by a tracking ADC as provided herein. It will be appreciated that FIGS. 2A and 2B and the associated descriptions are non-limiting embodiments of the disclosed DC-to-DC converter circuit, but are included herein to facilitate reader understanding. One skilled in the art will appreciate that variations on the operating principles shown in the DC-to-DC converters of FIGS. 2A and 2B may be made. For example, mixtures of the operating principles of DC-to-DC converter circuits 200 and 214 may be implemented in a single DC-to-DC converter circuit.

FIG. 2A is a block diagram of a DC-to-DC converter circuit 200 having a tracking ADC 204a that may be configured to drive a DC-to-DC converter 202a (e.g., to adjust the output voltage of DC-to-DC converter 202a). FIG. 2A shows a DC-to-DC converter circuit 200 where a digital ADC output signal S₁, output from the tracking ADC 204a, may comprise a digital code that is a digital representation of the feedback voltage V_{FB} (e.g., an output/feedback voltage of 5 V results in a digital code of “500”, an output/feedback voltage of 3 V results in a digital code of “300”). The DC-to-DC converter 202a receives the digital ADC output signal S₁, compares the digital code associated with the digital ADC output signal S₁ with a target code value S_{code}, and either raises or lowers the output voltage V_{OUT} based upon the comparison (e.g., to attempt to achieve a digital ADC output signal S₁ having a particular digital code equal to target code value S_{code}). This results in the tracking ADC 204a consistently operating to adjust the output voltage V_{OUT} of the DC-to-DC converter.

The tracking ADC 204a may comprise a feedback loop having a digital-to-analog converter (DAC) 206, a comparator 208, and a logic circuit 210a. The DAC 206 is configured to receive a digital ADC feedback signal S₁′, having a digital code, output from the logic circuit 210a. In various embodiments, the digital ADC feedback signal S₁′ may comprise the digital ADC output signal S₁, output from logic circuit 210a, or some variation thereof. The DAC 206 will generate an analog reference voltage V_{REF} based upon the digital code of the received digital ADC feedback signal S₁′. For example, a digital ADC feedback signal S₁′ having a digital code comprising an integer value of “100” may be received by DAC 206, resulting in DAC 206 generating and outputting an analog reference voltage V_{REF} of 1V.

The comparator 208 comprises a first input node and a second input node. The first input node is configured to receive the analog reference voltage V_{REF} output from DAC 206. The second input node is configured to receive an analog feedback voltage V_{FB} output from the DC-to-DC converter 202a. The comparator 208 is configured to compare the reference voltage V_{REF} to the feedback voltage V_{FB}, and based upon the comparison to output a comparator signal S_{c} to the logic circuit 210a. In one embodiment, the comparator signal S_{c} indicates whether the reference voltage V_{REF} is smaller than the feedback voltage V_{FB} (e.g., S_{C}=“1”) or larger than the feedback voltage (e.g., S_{C}=“0”).

The logic circuit 210a receives the comparator signal S_{c} and based thereupon generates the digital ADC output signal S₁. As shown in DC-to-DC converter circuit 200, the digital ADC output signal S₁ may be a digital representation of the feedback voltage V_{FB} that indicates what adjustment (e.g., an increase or decrease) to the output of the DC-to-DC converter 202a V_{OUT} should be made.

The digital ADC output signal S₁ is provided to the DC-to-DC converter 202a. The DC-to-DC converter 202a may comprise a regulator configured to compare the digital code comprised within the received digital ADC output signal S₁ to a target code value S_{code} and to take an appropriate action (e.g., raise or lower the output voltage V_{OUT}) based upon the comparison. Since the digital code is a digital representation of the feedback voltage V_{FB}, the regulator will attempt to modify the output voltage V_{OUT} so that the digital code achieves the desired voltage (e.g., target code value S_{code}). For example, if digital ADC output signal S₁ has a first code that is larger than a target code value S_{code} it may indicate to the DC-to-DC converter 202a that it is outputting a voltage that is larger than a desired voltage, and that the output voltage V_{OUT} should be decreased. Similarly, if the digital ADC output signal S₁ has a second, different, code that is smaller than the target code value S_{code} it may indicate to the DC-to-DC converter 202a that it is outputting a voltage that is smaller than the desired voltage, and that the output voltage V_{OUT} should be increased.

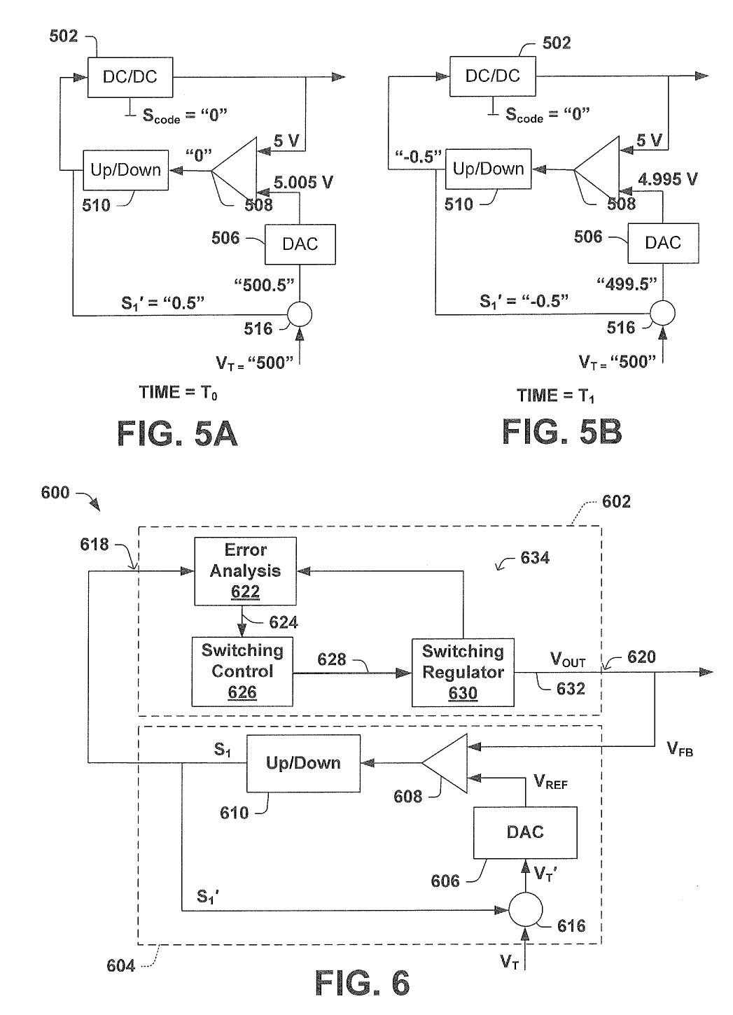

In one embodiment, the logic circuit 210a may comprise an up/down counter. (See, e.g., FIGS. 5 and 6 described infra). The up/down counter may be configured to receive a digital comparator signal S_{c} from comparator 208, which drives operation of the up/down counter. Based upon the comparator signal, the up/down counter will increment or decrement its state, so as to generate a digital ADC output signal that causes a reference voltage V_{REF} to track an output voltage V_{OUT}. For example, if the feedback voltage V_{FB} is larger than the reference voltage V_{REF}, the up/down counter goes into the “count up” mode, thereby incrementing the digital ADC output signal S₁ (e.g., from “200” (digitally representing 2V) to “201” (digitally representing 2.01V)). If the feedback voltage V_{FB} is smaller than the reference voltage V_{REF}, the counter switches into the “count down” mode, thereby decrementing the digital ADC output signal S₁ (e.g., from “200” (representing 2V) to “199” (representing 1.99V)). Therefore, the up/down counter output will count in the proper direction to track the feedback voltage V_{FB}.

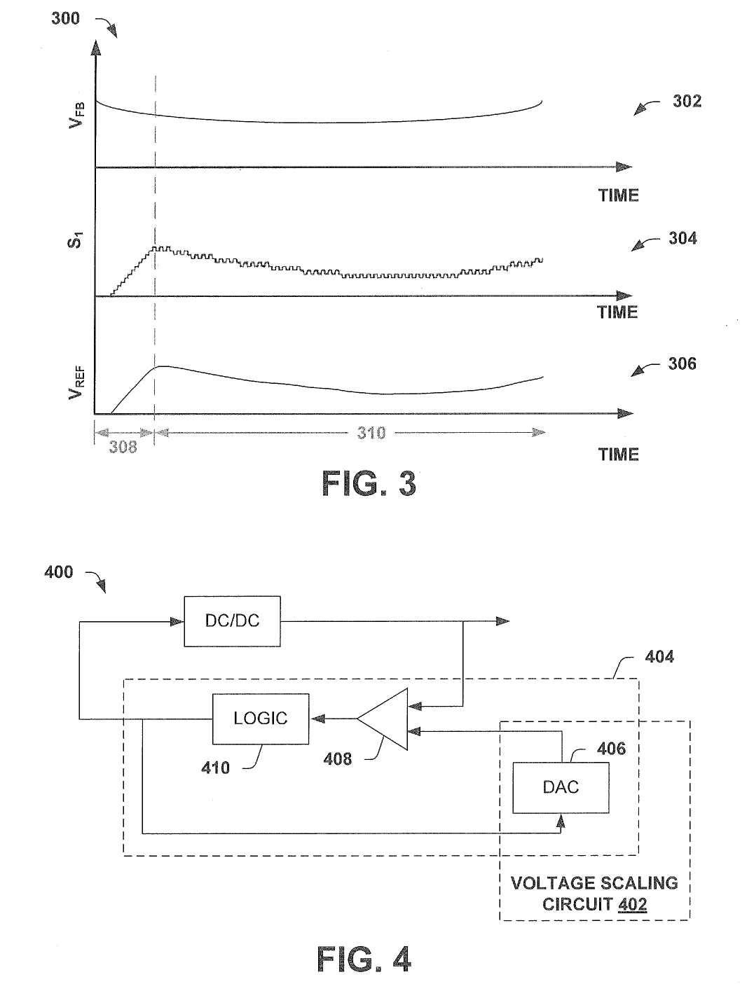

FIG. 3 illustrates a graph 300 showing signals V_{FB}, S₁, and V_{REF} during operation of DC-to-DC converter 200 over an extended time. It will be appreciated that in a conventional DC-to-DC converter circuit, transient steps usually take a plurality of PWM-cycles to regulate, wherein each PWM-cycle consists of several “LOGIC” cycles. Therefore, the signal lines (302, 304, 306) may undergo hundreds of such “LOGIC” cycles during the course of the transient operation shown in FIG. 3.

As shown in FIG. 3, signal line 302 shows a typical transient behavior of the analog feedback voltage V_{FB}, which varies slowly with time. Signal line 304 illustrates the digital ADC output signal S₁. Signal line 306 illustrates the reference voltage V_{REF}.

If the tracking ADC 204a is off-target, as shown at the beginning of the graph (region 308), the digital ADC output signal S₁ has to catch up with the analog feedback voltage V_{FB} and therefore the ADC output signal S₁ may iteratively be adjusted over multiple feedback cycles (e.g., toggling up/down to produce a ramp of the codes in-between the starting code and a code corresponding to the analog feedback voltage). In particular, during the ramp up stage (region 308), the ADC output signal S₁ attempts to adjust the reference voltage V_{REF} 306 towards the feedback voltage V_{FB} 302. Since feedback voltage V_{FB} 302 is larger than the reference voltage V_{REF} 306, the comparator 208 will output a comparator signal S_{c} having a high data state (e.g., “1”) that results in a digital ADC output signal S₁ 304 having an incremented digital code. Continual incrementation of the digital code will cause the reference voltage V_{REF} 306 to quickly increase until it has caught up to the analog feedback voltage V_{FB} 302.

Once the digital ADC output signal S₁ 304 has caught up with the analog feedback voltage V_{FB} 302, it will achieve a steady state, shown in region 310 (e.g., following the much slower transient produced by the DC/DC). In the steady state (region 310), the up/down counter may toggle between two adjacent reference voltages V_{REF} 306 since the up/down counter is continuously incrementing or decrementing the digital code of the ADC output signal S₁ 304.

In the steady state (region 310), since the digital code of ADC output signal S₁ 304 represents the feedback voltage, the digital code may also regulate the output voltage V_{OUT} of the DC-to-DC converter. For example, the digital ADC output signal S₁ 304 will be received by the DC-to-DC converter and the digital code is compared to a target code value S_{code}. If the target code value S_{code} is larger than the digital code of the digital ADC output signal S₁, the DC-to-DC converter will increase its output voltage. The increased output voltage is fed back to the comparator 208 which once again performs a comparison. Similarly, if the target code value S_{code} is smaller than the digital code of the digital ADC output signal S₁, the DC-to-DC converter will decrease its output voltage.

It will be appreciated that the DC-to-DC converter 202a may typically comprise an inductor that is responsible for energy conversion and that provides for an output signal that passes through a large capacitor 212. The capacitor 212 will build up charge over time due to the output current of the DC-to-DC converter 202a. When the output current cannot satisfy the needs of a load, the capacitor 212 will discharge, thereby keeping the output voltage of the DC-to-DC converter V_{OUT} relatively constant. The use of a large capacitor (e.g., 10 pF) may keep the output voltage of the DC-to-DC converter stable even in the presence of load jumps (e.g., a varying active load) and/or line jumps. For example, in modern applications, the switching frequency of a DC-to-DC regulator might be on the order of 1 MHz whereas internal clock speeds might be on the order of 100 MHz or more. In such applications, because of the capacitor 212, the small movements of voltages (e.g., codes) within one switching period are possible without causing significant problems with the DC-to-DC output.

In one embodiment, wherein the DC-to-DC converter circuit 200 is used in a system that performs dynamic voltage scaling, a DAC may be shared between a voltage scaling circuit and the DC-to-DC converter circuit. For example, in FIG. 4 DAC 406 may comprise a DAC used in a voltage scaling circuit 402. Such an embodiment allows a DAC already present in a system (as part of a voltage scaling circuit 402) to be also used in the tracking ADC 404, thereby reducing the chip area required to implement tracking ADC 404 to an area that comprises one comparator 408 and a logic circuit 410.

FIG. 2B is a block diagram of a digital DC-to-DC converter circuit 214 having an alternative tracking ADC 204b that may be configured to drive a DC-to-DC converter 202b. In DC-to-DC converter circuit 214, the digital ADC output signal S₁ comprises a digital code indicating a positive or negative error in the feedback voltage V_{FB}/output voltage V_{ag}. The digital code causes the output voltage V_{ag} of the DC-to-DC converter 202b to increase or decrease.

In one embodiment, the digital DC-to-DC converter 202b may comprise a regulator configured to regulate the output voltage V_{OUT} compared to a zero (“0”) input. In such an embodiment, the DC-to-DC converter 202b will try to regulate the output voltage V_{OUT} to counteract any deviation of the digital ADC output signal S₁ from a code value of zero. To accomplish this, the DC-to-DC converter 202b may be configured to compare the digital code of ADC output signal S₁ with a target code value S_{code} of zero and to take appropriate action based on the comparison. In one embodiment, DC-to-DC converter circuit 214 may be configured to have an ADC output signal S₁ shifted by an amount V_{T} with respect to DC-to-DC converter circuit 200 (FIG. 2A) (e.g., DC-to-DC converter circuit 200 may have a S₁ with a digital code corresponding to 4.99 V and a target code value S_{code} corresponding to 5 V, whereas if V_{T} comprises a digital code corresponding to 5V, DC-to-DC converter 214 may have a S₁ with a digital code corresponding to −0.01 V and a target code value S_{code} corresponding to 0 V). This shift in the ADC output signal allows for the DC-to-DC converter circuit 214 (FIG. 2B) to be configured to have a target code value code S_{code} that is substantially equal to zero, with proper dimensioning.

In order to understand the operation of the block diagram shown in FIG. 2B it will be appreciated that the digital DC-to-DC converter 202b is not configured to receive an absolute number, but instead is configured to receive a digital code indicating a positive or negative error. Similarly, the target value signal V_{T}, going into adder block 216, is a digital representation of a desired target output voltage (e.g., an output voltage requested by a user).

Digital codes may be used to represent errors (e.g., positive, negative, zero) in various ways. In one embodiment, digital codes having a bit indicating a positive or negative value may be used to represent errors. For example, a digital code of ‘1001’ corresponding to +1 indicates a slight positive error, a digital code ‘1010’ corresponding to +2 indicates a larger positive error, a digital code of ‘1011’ corresponding to +3 indicates an even larger positive error, a digital code of ‘1000’ or ‘0000’ indicates no error, a digital code of ‘0001’ corresponding to −1 indicates a slight negative error, etc. In an alternative embodiment, the relationship of a digital code to a target code may be used to represent errors. For example, for a target code corresponding to a decimal value of “100”, a digital code corresponding to a decimal value of “101” would indicate a slight positive error, a digital code corresponding to a decimal value of “102” would indicate a larger positive error, a digital code corresponding to a decimal value of “100” would indicate no error, a digital code corresponding to a decimal value of “99” would indicate a slight negative error, a digital code corresponding to a decimal value of “98” would indicate a larger negative error, etc. One of ordinary skill in the art will appreciate that alternative methods for representing errors using digital codes may be used for the converter circuit provided herein.

As shown in FIG. 2B, tracking ADC 204b further comprises an adder block 216 in the ADC feedback loop. The adder block 216 is configured to receive the digital ADC feedback signal S₁′ and a target value signal V_{T}, indicating a desired output voltage for the DC-to-DC converter 202b. The adder 216 is configured to add or subtract the ADC feedback signal S₁′ and a target value signal V_{T} to produce a digital signal V_{T}′ that corresponds to the reference voltage V_{REF}. Therefore, in an equilibrium state, the logic circuit 210b attempts to output a digital ADC output signal S₁ having a code of zero, which keeps the tracking ADC loop stable since the addition/subtraction of a digital code of zero to target value signal V_{T} (e.g., having some non-zero digital code corresponding to the desired output voltage) causes DAC 206 to output a desired analog reference voltage equal to the digital signal value. Therefore, when the system is in an equilibrium state and V_{REF} and V_{FB} are substantially the same value, a digital ADC output signal S₁ (e.g., and digital ADC feedback signal S₁′) equal to +/−“0.5” may be output from the logic circuit 210b (e.g., the digital code may be offset from “0” by 0.5 LSB so that the digital ADC output signal S₁ toggles during equilibrium). Adding the digital ADC feedback signal S₁′=+/−“0.5” to the target value signal V_{T} results in the DAC 206 outputting an analog reference voltage V_{REF} that is substantially equal to the desired output voltage V_{OUT}.

More particularly, during operation the logic circuit 210b will increment or decrement to try to produce a digital ADC output signal S₁ having a digital code that is equal to “0”. In the process it will adjust the output voltage V_{OUT} so that the digital signal V_{T}′ corresponds to the output voltage V_{OUT}. For example, if the tracking ADC is off target, (e.g., if a target code value Vt=100, a feedback voltage V_{FB}=1V, and a ADC output signal S₁=300 instead of S₁=0, cause a target code value Vt′=400 to produce a reference voltage V_{REF}=4V) the logic circuit 210b will decrement the digital code of the digital ADC output signal S₁ (e.g., until it reaches a digital code value of “0”) until that the feedback voltage V_{FB} and the reference voltage V_{REF} are substantially at equilibrium.

Once at equilibrium, the ADC output signal will toggle between values, as shown in FIGS. 5A and 5B. In FIGS. 5A and 5B, the ADC output signal S₁ comprises a digital code corresponding to half an LSB. In alternative embodiments, the DAC 506 could have an offset value of half an LSB, or the target code S_{code} of the DC-to-DC converter could be set to a value of +0.5 (e.g., a value of 0.5 is added to a target code S_{code} of zero).

At time T₀ (FIG. 5A), a target value signal V_{T} having a digital code of “500” is provided to an adder 516 configured to add S₁′ to V_{T}. The adder 516 is configured to also receive a digital ADC feedback signal S₁′ having a digital code of “0.5” from logic circuit 510 (e.g., an integer code of “0” offset by 0.5LSB). The adder 516 adds the digital codes (e.g., “500”+“0.5”=“500.5”) and sends a digital code of “500.5” to DAC 506. DAC 506 receives the digital code of “500.5” and converts it to an analog signal, having a voltage of 5.005V that is output as a reference voltage. The comparator 508 receives the 5.005V reference voltage V_{REF} and a 5V feedback voltage V_{FB} from DC-to-DC converter 502. Since V_{REF} is larger than V_{FB}, the comparator 508 will output a low signal (e.g., “0”). The logic circuit 510 will receive the low signal and will decrement the digital ADC output signal S₁ to have a code “−0.5”.

At time T₁ (FIG. 5B) (e.g., a next clock cycle), the adder block 516 adds the ADC output signal S₁=−0.5 to the target value of “500” to get a V_{REF} of 4.995V (e.g., “500”+“−0.5”=“4.995”). Since the feedback voltage V_{FB}, output from the DC-to-DC converter 502, is larger than the reference voltage V_{REF}, the comparator 408 will output a high signal (e.g., “1”). The logic circuit 510 will receive the high signal and will output a digital ADC output signal S₁ having a code “0.5”. The digital ADC output signal S₁ is provided as a feedback to the tracking ADC loop and to the DC-to-DC converter 502. The adder block 516 receives the digital ADC output signal S₁ and increases the reference voltage to 500.5V. This cycle repeats (e.g., as the output signal toggles between −0.5 and +0.5 as described in paragraphs [0040]-[0041]) during equilibrium, thereby toggling the reference voltage V_{REF} between two adjacent voltages.

In one embodiment, the tracking ADC 204b of FIG. 2B may be used to enable digital voltage scaling in the DC-to-DC converter circuit 200 (e.g., a user may indicate a voltage setting such as a low power mode on a laptop that is associated with a voltage that is provided as target value signal V_{T}, which is a digital number that represents the output voltage that the user wants to have from the DC-to-DC converter 202b).

FIG. 6 is a block diagram illustrating a more particular embodiment of a DC-to-DC converter 602 (e.g., corresponding to DC-to-DC converter 102). It will be appreciated that the DC-to-DC converter illustrated in FIG. 6 is an exemplary DC-to-DC converter circuit and is not to be construed in a limiting manner. Furthermore, alternative designs of a DC-to-DC converter may be implemented into the DC-to-DC converter circuit, as provided herein.

As illustrated in FIG. 6, the DC-to-DC converter 602 includes an input terminal 618 and an output terminal 620. During operation, a digital ADC output signal S₁ output from the tracking ADC 604, is provided at the input terminal 618. Based upon the digital ADC output signal S₁, the DC-to-DC converter 602 will adjust its output to provide a DC output voltage V_{OUT} having a desired voltage level.

More particularly, during operation, an error analysis unit 622 is configured to receive the digital ADC output signal S₁ comprising a digital code. The error analysis unit 622 performs analysis of the digital code and therefrom generates an error signal 624 that enables the switching control circuit generate a control signal that adjusts the output voltage level V_{OUT}. In one embodiment, the error analysis unit 622 compares the received digital code to a target code value S_{code} and generates an error signal 624 based upon the comparison.

If the error analysis unit 622 determines from the received digital code that the output voltage level V_{OUT} is to be increased, the error signal 624 can enable the switching control circuit 626 to change the control signal 628 to increase the output voltage level V_{OUT}. Conversely, if the error analysis unit 622 determines from the received digital code that the output voltage level V_{OUT} is to be decreased, the error signal 624 can enable the switching control circuit 626 to change the control signal 628 and decrease the output voltage level V_{OUT}.

The switching control unit will receive the error signal 624 and therefrom generate a control signal 628. The switching control circuit 626 may provide a control signal 628 having a duty cycle, for example. As used herein, the term “duty cycle” describes a fraction of time that the control signal 628 is in an active state relative to an inactive state (or vice versa). For example, a 30% duty cycle can indicate that the control signal 628 is in a continuous active state for 30% of a control signal period and is in a continuous inactive state for the remaining 70% of the control signal period.

The switching regulator 630 receives the control signal 628. Based on the control signal 628, the switching regulator 630 provides a DC output signal V_{OUT} at the output terminal 620. The switching regulator 630 therefore acts as a voltage regulator that uses a switching element to adjust the output voltage V_{OUT}. In various embodiments, the DC-to-DC converter 602 may also include regulation and filtering components to insure a steady output.

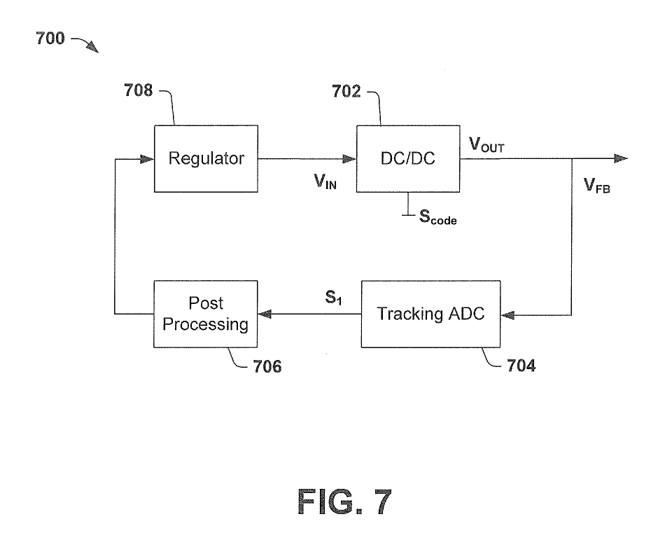

FIG. 7 illustrates a DC-to-DC converter circuit 700 comprising a post processing block 706 (post processing unit) coupled to the output of the tracking ADC 704. Since the tracking ADC 704 can produce a number of output codes (i.e., corresponding to analog voltages) within one switching period, post processing may be beneficial. For example, post processing may be used to calculate a mean value per switching period for the output of the tracking ADC (e.g., digital ADC output signal S₁).

In one embodiment, a regulator 708 comprised within DC-to-DC converter circuit 700 will try to enforce a sequence of digital ADC output signals S₁ (e.g., output from the tracking ADC 704) to have digital code values of +0.5 and −0.5, which in average give 0. In another embodiment, digital ADC output signals S₁ having digital codes toggling between (0,1,0,1) or (0,−1,0,−1) may lead to post processing values of +0.5 or −0.5 after averaging. This feature may be used to eliminate dead zones during operation.

It will be appreciated that the post processing block 706 indicates a post processing functionality that may take place in various places in the DC-to-DC converter circuit 700. In one embodiment, the post processing block 706 could be part of a regulator 708 that may be comprised within the DC-to-DC converter 702. In an alternative embodiment, the post processing block 706 may be part of the tracking ADC 704. As part of the tracking ADC 704, the post processing block 706 can make use of the quasi continuous information that is output from the tracking ADC 704, as the tracking ADC 704 following the reference signal at each clock cycle.

Furthermore, in various embodiments the post processing block may be configured to perform a wide range of post processing actions. For example, in one embodiment, the post processing block 706 may be configured to read out 4 or 8 samples and average them to get an average digital ADC output signal S₁. In another embodiment, the post processing block 706 may be configured to generate a weighted average of the digital ADC output signal S₁. For example, to emphasize the signal characteristics present at the end of a cycle the post processing block may multiply the digital ADC output signal S₁ with a weighting value that is a function of time (e.g., weighting value, w(t)=A+b*t, where b>0 and where t is the time within a given cycle) so that ADC output signals received at the end of a cycle are multiplied by a larger weighting factor than ADC output signals received at beginning of a cycle.

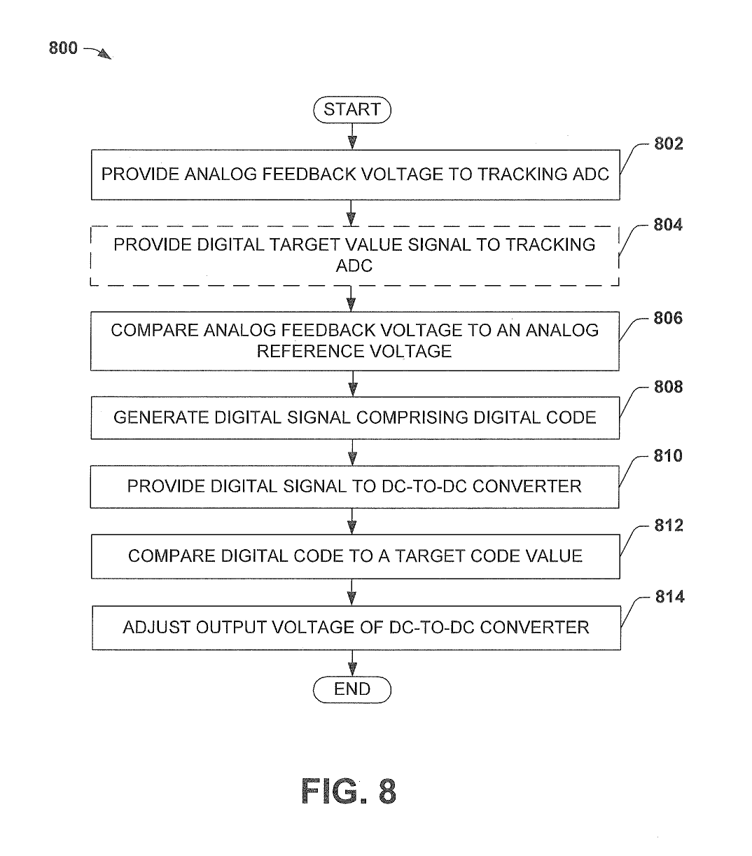

FIG. 8 is a flow diagram illustrating an exemplary method performing a voltage conversion (e.g., a DC-to-DC conversion). The method relies upon driving a digital voltage converter using a tracking ADC converter. The method is described below in relation to a DC-to-DC conversion but may apply to other voltage conversions as well (e.g., an AC-to-DC conversion).

While these methods are illustrated and described below as a series of acts or events, the present disclosure is not limited by the illustrated ordering of such acts or events. For example, some acts may occur in different orders and/or concurrently with other acts or events apart from those illustrated and/or described herein. In addition, not all illustrated acts are required and the waveform shapes are merely illustrative and other waveforms may vary significantly from those illustrated. Further, one or more of the acts depicted herein may be carried out in one or more separate acts or phases.

Furthermore, the claimed subject matter may be implemented as a method, apparatus, or article of manufacture using standard programming and/or engineering techniques to produce software, firmware, hardware, or any combination thereof to control a computer to implement the disclosed subject matter (e.g., the circuits shown in FIGS. 1, 2A, 2B, etc., are non-limiting examples of circuits that may be used to implement method 700). The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

At 802 an analog feedback voltage is provided to a tracking ADC. The analog feedback voltage may be provided from the output of a DC-to-DC converter and in various embodiments may comprise the output voltage of the DC-to-DC converter or some part of the output voltage. In one embodiment, a comparator circuit comprised within a tracking ADC is configured to receive the analog feedback voltage at a first input and an analog reference voltage at a second input.

A digital target value signal may optionally be provided to the tracking ADC at 804. The target value signal may comprise a digital code that indicates (i.e., is a digital representation) of a desired DC-to-DC converter output voltage value that is requested by a user. In one embodiment, the digital target value signal may be converted to a voltage (e.g., by a DAC configured to generate a voltage based upon the digital target value signal). In one embodiment, the voltage may comprise the analog reference voltage.

At 806 the analog feedback voltage is compared to an analog reference voltage. The comparison may be performed by a comparator and results in a comparator signal that indicates whether the reference voltage is smaller than the feedback voltage (e.g., S_{C}=“1”) or whether the reference voltage is larger than the feedback voltage (e.g., S_{C}=“0”).

A digital ADC output signal, having a digital code, is generated by the tracking ADC in response to the comparison between the feedback voltage and a reference voltage at 808. The comparison produces a digital ADC output signal that results in a reference voltage that matches the feedback voltage as closely as possible. In particular, the digital ADC output signal may be incremented or decremented based upon the comparator signal (e.g., S_{C}=“1” or “0”). The digital ADC output signal drives operation of the DC-to-DC converter by indicating an adjustment that is to be made to the output of the DC-to-DC converter (e.g., by telling the DC-to-DC converter to increase its output voltage or to decrease its output voltage). In one embodiment, the reference voltage may be based upon the digital target value signal.

The digital signal is provided to a DC-to-DC converter at 810. In one embodiment, the digital signal may be received by an analysis circuit configured to perform analysis of the digital code.

At 812 the digital code, comprised within the digital signal, is compared to a target code value. Based upon the comparison, the output voltage of the DC-to DC converter may be appropriately adjusted (e.g., raise or lower the output voltage V_{OUT}). For example, if digital ADC output signal S₁ has a first code that is larger than a target code value S_{code} it indicates to the DC-to-DC converter that it is outputting a voltage that is larger than the desired voltage and that the output voltage should be decreased. Similarly, if the digital ADC output signal S₁ has a second, different, code that is smaller than the target code value S_{code} it indicates to a DC-to-DC converter that it is outputting a voltage V_{OUT} that is smaller than the desired voltage and that the output voltage should be increased.

At 814 the output voltage of the DC-to-DC converter is adjusted. The output voltage of the DC-to-DC converter is adjusted in response to the comparison of the digital code to the target code value. For example, if the feedback voltage is lower than its target value the tracking ADC will produce codes lower than the target code S_{code} (e.g., as described in steps 806 and 808). After comparing these codes with S_{code} (e.g., as described in step 812) the DC-to-DC converter increases its output voltage.

It will be appreciated that method 800 may be iteratively performed to achieve a desired output voltage. For example, the adjustment to the output voltage of the DC-to-DC converter may be small so as to not achieve the desired output voltage in a single iteration of the method. For example, during a soft start interval, the method may provide for a DC output signal that is gradually ramped up to predetermined desired voltage level.

Although examples of techniques that are consistent with some implementations have been illustrated and described with respect to one or more implementations above, alterations and/or modifications may be made to the illustrated examples without departing from the spirit and scope of the appended claims. For example, although a tracking ADC is illustrated as driving a digital DC-to-DC converter, the inventive concept of using a tracking ADC may also be applicable to AC-to-DC power converters. Furthermore, although various ADCs and digital codes are used within this disclosure these are only used to facilitate reader understanding and are not intended to limit the scope of the invention.

Furthermore, although the comparator provided herein is described as a two valued comparator, it will be appreciated that the comparator is not limited to a two valued comparator. For example, the tracking ADC provided herein may utilize one or more comparators configured to implement three comparator values during operation. One such exemplary three valued comparator system may have a comparator configured to receive digital signals from a logic circuit, wherein if the logic circuit outputs a digital error signal having a code with a “0”, it indicates to the DC-to-DC converter that it is outputting the desired voltage, if the logic circuit outputs a digital error signal having a code that is a negative number (e.g., “−1”) it indicates to the DC-to-DC converter that it is outputting a voltage that is larger than the desired voltage, and if the logic circuit outputs a digital error signal having a code that is a positive number (e.g., “1”) it indicates to the DC-to-DC converter that it is outputting a voltage that is smaller than the desired voltage.

Moreover, certain terms are used throughout the specification to refer to particular system components. As one skilled in the art will appreciate, different companies can refer to a component by different names. This document does not intend to distinguish between components that differ in name but not function herein. In this document the terms “including” and “comprising” are used in an open ended fashion, and thus should be interpreted to mean “including, but not limited to . . . ” Also, the term “couple” (and variations thereof) is intended to mean either an indirect or direct electrical connection. Thus, if a first element couples to a second element, that connection may be a direct electrical connection, or may be an indirect electrical connection via other elements and connections.

Although various numeric values are provided herein, these numeric values are merely examples should not be used to limit the scope of the disclosure. Also, all numeric values are approximate.

In addition, while a particular feature may have been disclosed with respect to only one of several implementations, such feature may be combined with one or more other features of the other implementations as may be desired and advantageous for any given or particular application.

What is claimed is:

1. A circuit, comprising:
a tracking analog-to-digital (ADC) converter configured to output a digital ADC output signal comprising; and
a voltage converter configured to receive the digital ADC output signal and to adjust an output voltage of the voltage converter based thereupon.

2. The circuit of claim 1, wherein the digital ADC output signal comprises a digital code indicative of an adjustment to the output voltage.

3. The circuit of claim 2,
wherein the tracking ADC converter is configured to generate the digital code from a comparison between an analog feedback voltage, based upon the output voltage, and an analog reference voltage; and
wherein the voltage converter is configured to compare the digital code to a target code value and to adjust the output voltage based upon the comparison of the digital code and the target code value.

4. The circuit of claim 3, wherein the tracking ADC comprises:
a digital to analog converter (DAC) configured to receive an ADC feedback signal comprising the digital code and to output the analog reference signal based upon the received ADC feedback signal;
a comparator configured to compare the analog reference signal and the analog feedback signal and to output a comparator signal that indicates whether the analog reference voltage is larger or smaller than the analog feedback voltage; and
a logic circuit configured to receive the comparator signal and to generate the digital ADC output signal based thereupon.

5. The circuit of claim 4, wherein the tracking ADC further comprises an adder configured to add the ADC feedback signal, based upon the digital ADC output signal output from the logic circuit, to a target value signal,
wherein the target code value is substantially equal to zero
and wherein the digital code indicates a positive or negative error in the feedback voltage.

6. The circuit of claim 5, wherein the digital code is a digital representation of the analog feedback voltage and wherein the target value signal indicates a desired output voltage of the circuit.

7. The circuit of claim 4, wherein the logic circuit comprises an up/down counter configured to increment or decrement its state depending on the comparator signal.

8. The circuit of claim 4, wherein the DAC is shared by both the tracking ADC and a dynamic voltage scaling circuit.

9. The circuit of claim 1, further comprising a post processing unit configured to receive the digital ADC output signal and to calculate a mean value per switching period for the output of the tracking ADC.

10. The circuit of claim 1, wherein the voltage converter comprises:
an error analysis unit configured to receive the digital ADC output signal and to generate an error signal;
a switching control circuit configured to receive the error signal and based thereupon to generate a control signal controlling adjustments to the output voltage by varying a duty cycle; and
a switching regulator to receive a control signal and based thereupon to regulate the output voltage.

11. The circuit of claim 1, wherein the voltage converter comprises a DC-to-DC converter.

12. A method for performing voltage conversion, comprising:
providing an analog feedback voltage to a tracking analog-to-digital converter (ADC);
comparing the analog feedback voltage to an analog reference voltage;
generating a digital ADC output signal based upon a comparison of the analog reference voltage and the analog feedback signal;
providing the digital ADC output signal to a voltage converter;
comparing the digital ADC output signal to a target code value; and
adjusting an output voltage of the voltage converter based the comparison of the digital ADC output signal to the target code value.

13. The method of claim 12, wherein the digital ADC output signal comprises a digital code indicative of an adjustment to an output voltage of the voltage converter circuit.

14. The method of claim 13, wherein the analog reference signal is generated by a digital to analog converter (DAC) configured to receive a signal comprising a second digital code and to output the analog reference signal based upon the received signal.

15. The method of claim 14, wherein the DAC is shared by both the tracking ADC and a dynamic voltage scaling circuit.

16. The method of claim 13, further comprising:
adding an ADC feedback signal based upon the digital ADC output signal output from the logic circuit and a target value signal, wherein the target code value is substantially equal to zero
and wherein the digital code indicates a positive or negative error in the feedback voltage.

17. The method of claim 13, wherein the digital code is a digital representation of the analog feedback voltage and wherein the target value signal indicates a desired output voltage of the voltage converter

18. The method of claim 12, further comprising performing post processing actions on the digital signal ADC output prior to providing the digital ADC output signal to the voltage converter, wherein the post processing actions calculate a mean value per switching period for the output of the tracking ADC.

19. The method of claim 12, wherein adjusting the output voltage of the voltage converter, comprises:
generating an error signal based upon the received digital signal; and
generating a control signal based upon the received ADC output digital signal,
wherein the control signal is provided to drive a voltage regulator to adjust the output voltage by varying a duty cycle.

20. A voltage converter circuit, comprising:
a tracking analog-to-digital converter (ADC) configured to receive an analog feedback voltage, and to output a digital ADC output signal, comprising a digital code indicative of an adjustment to an output voltage of the voltage converter circuit, based upon a comparison between the analog feedback voltage and an analog reference voltage; and
a DC-to-DC converter configured to receive the digital ADC output signal, to compare the digital code to a target code value, and to adjust the output voltage based upon the comparison of the digital code and the target code value,
wherein the analog feedback voltage is based upon the output voltage of the DC-to-DC converter.
